(19) United States
(12) Patent Application Publication
(10) Pub. No.: US 2015/0067610 A1
(43) Pub. Date: Mar. 5, 2015

(54) IMAGE FORMING APPARATUS AND STORAGE MEDIUM

(71) Applicant: KYOCERA DOCUMENT SOLUTIONS INC., Osaka (JP)

(72) Inventor: Tomoharu TOKUNAGA, Osaka (JP)

(73) Assignee: KYOCERA DOCUMENT SOLUTIONS INC., Osaka (JP)

(21) Appl. No.: 14/458,719

(22) Filed: Aug. 13, 2014

(30) Foreign Application Priority Data
Aug. 29, 2013 (JP) 2013-177941

(51) Int. Cl. G06F 3/0482; G06F 17/30

(52) U.S. Cl. CPC G06F 3/0482; G06F 17/30292
USPC 715/841

(57) ABSTRACT

An image forming apparatus includes a menu management section, a variant-attribute menu management section, and a display processing section. The menu management section manages a tree structure including a plurality of menus hierarchized according to their attributes. The variant-attribute menu management section manages a variant-attribute menu associated with a specified menu as a quasi lower-level menu. The specified menu is classified according to its variant attribute different from corresponding one of the attributes used for the tree structure. The display processing section displays the quasi lower-level menu on a display according to selection of the variant-attribute menu and displays, once the quasi lower-level menu is selected, a next-lower-level menu of the quasi lower-level menu on the display based on path information and the tree structure. The path information shows pathways to be selected to reach the specified menu in the tree structure.

### INCORPORATION BY REFERENCE

The present application claims priority under 35 U.S.C. §119 to Japanese Patent Application No.2013-177941, filed Aug. 29, 2013. The contents of this application are incorporated herein by reference in their entirety.

### BACKGROUND

The present disclosure relates to image forming apparatuses and non-transitory computer-readable storage media storing a display program.

Image forming apparatuses such as digital multifunction peripherals manage a plurality of hierarchized menus as a tree structure. When a user selects a menu in a higher level displayed on a screen in such an image forming apparatus, the screen shows menus that are included in a lower level than that of the menu selected and that are associated with the menu selected.

Thus, the user can cause a desired menu to be shown by sequentially selecting any of the menus in every level, and then input operation for setting a device.

However, some low-end image forming apparatuses are not capable of displaying other information than menus for each level because of screen constraints. It is therefore sometimes difficult to reach a desired menu. That is, it is impossible to efficiently reach a desired menu because a user often needs to move back and forth among levels, for example.

On the contrary, a certain image forming apparatus has or acquires from a network or the like an operating manual provided in the form of electronic data and outputs a piece of information necessary for a user.

Such an image forming apparatus allows the user to easily reach a desired menu with referring to the operating manual.

However, some users may find it burdensome to input operation with referring to the operating manual even if they need to refer only to the necessary piece of information. In addition, even with the operating manual output, the user needs to select one menu in every level in order to reach the desired menu.

### SUMMARY

An image forming apparatus according to the present disclosure includes a menu management section, a variant-attribute menu management section, a path information management section, and a display processing section. The menu management section manages a tree structure including a plurality of menus hierarchized according to their attributes. The variant-attribute menu management section manages a variant-attribute menu associated with a specified menu out of the plurality of menus as a quasi lower-level menu located in a quasi next lower level. The specified menu is classified according to its variant attribute different from corresponding one of the attributes used for the tree structure. The path information management section manages path information showing pathways to be selected to reach the specified menu in the tree structure. The display processing section displays the quasi lower-level menu on a display according to selection of the variant-attribute menu. Once the quasi lower-level menu is selected, the display processing section displays a next-lower-level menu of the quasi lower-level menu on the display based on the path information and the tree structure.

A non-transitory computer-readable storage medium according to the present disclosure stores a display program configured to cause a computer to execute processing including: managing a tree structure including a plurality of menus hierarchized according to their attributes; managing a variant-attribute menu associated with a specified menu out of the plurality of menus as a quasi lower-level menu located in a quasi next lower level, the specified menu being classified according to its variant attribute different from corresponding one of the attributes used for the tree structure; managing path information showing pathways to be selected to reach the specified menu in the tree structure; displaying the quasi lower-level menu on a display according to selection of the variant-attribute menu; and displaying a next-lower-level menu of the quasi lower-level menu on the display based on the path information and the tree structure once the quasi lower-level menu is selected.

### BRIEF DESCRIPTION OF THE DRAWINGS

FIG. 1 is a block diagram showing a configuration of an image forming apparatus according to an embodiment of the present disclosure.

FIG. 2 is a diagram showing a tree structure of a plurality of menus according to the present embodiment.

FIG. 3 is a conceptual diagram showing a part of first screen transition information indicating the association between a first-level menu and its lower-level menus according to the present embodiment.

FIG. 4 is a diagram showing a plurality of quasi hierarchized menus according to the present embodiment.

FIG. 5 is a conceptual diagram showing a part of second screen transition information indicating the association between a guide menu and its lower-level menus according to the present embodiment.

FIG. 6A is a conceptual diagram showing a data structure of the path information of a menu “Sleep Level” according to the present embodiment.

FIG. 6B is a conceptual diagram showing a data structure of the path information of a menu “Status” according to the present embodiment.

FIG. 6C is a conceptual diagram showing a data structure of the path information of a menu “Sleep Timer” according to the present embodiment.

FIG. 7 is a flowchart showing display processing to be executed by the image forming apparatus according to the present embodiment.

FIG. 8 is a diagram showing a part of screen transition according to menu selection through the guide menu according to the present embodiment.

### DETAILED DESCRIPTION

An image forming apparatus according to an embodiment of the present disclosure manages a tree structure including a plurality of menus hierarchized according to their attributes. At the same time, the image forming apparatus according to the present embodiment classifies specified menus out of the plurality of menus according to their variant attributes different from the attributes (original attributes) used as a reference when the tree structure is built and associates the specified menus as menus in a quasi next lower level (hereinafter, may be referred to as quasi lower-level menus) with variant-attribute menus. The variant-attribute menus are menus that are not included in the tree structure.

The image forming apparatus according to the present embodiment manages path information. The path information shows pathways to be selected to reach from a menu located in the highest level in the tree structure to a specified menu. When a variant-attribute menu is selected, the image forming apparatus according to the present embodiment displays on a display a menu associated with the specified menu (quasi lower-level menu) and located in a next lower level to that of the specified menu based on the path information and the tree structure. Such a configuration can allow a user to efficiently reach a desired menu (operate a desired menu) without referring to an operating manual when trying to display the desired menu out of a plurality of hierarchize menus.

Hereinafter, an embodiment of the present disclosure will be described in detail with reference to the accompanying drawings.

### Configuration of Image Forming Apparatus

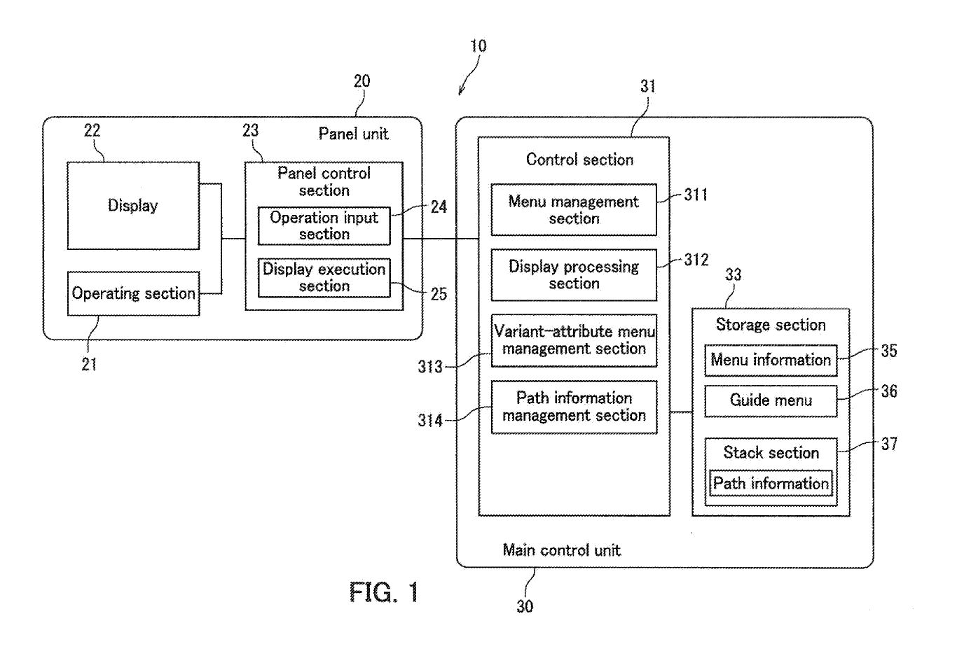

FIG. 1 is a block diagram showing a configuration of an image forming apparatus according to an embodiment of the present disclosure.

An image forming apparatus 10 of the present embodiment is a digital multifunction peripheral. A digital multifunction peripheral includes various functions such as a printing function, a copy function, and a facsimile function. The image forming apparatus 10 includes a panel unit 20 and a main control unit 30 as shown in FIG. 1 as well as components corresponding to the various functions. The components corresponding to the various functions are not shown in FIG. 1.

The panel unit 20 includes an operating section 21, a display 22, and a panel control section 23.

The operating section 21 has various operation keys including a numeric keypad (numeric keys). Data according to operation (press) of each operation key by a user is input into a control section 31.

The display 22 is a liquid crystal display device, for example. The display 22 displays a result of a response to the data input through the operating section 21 (input result), the status of the apparatus, and so on.

The panel control section 23 is a computing device such as a processor. The panel control section 23 is operable as an operation input section 24 and a display execution section 25 through execution of a program.

The operation input section 24 provides an operation inputting function. Specifically, the operation input section 24 generates input data according to press or release of any of the operation keys by a user. The input data is notified to the main control unit 30.

The display execution section 25 provides a display executing function. For example, the display execution section 25 displays on the display 22 a result of processing executed by the main control unit 30 based on the input data.

The main control unit 30 performs overall control of the image forming apparatus 10. The main control unit 30 has the control section 31 and a storage section 33.

The control section 31 is a computing device such as a central processing unit (CPU). The storage section 33 includes a read only memory (ROM) storing a program, a random access memory (RAM) as a work area, a hard disk drive (HDD) as an auxiliary storage device, and the like.

The control section 31 is operable as a menu management section 311, a display processing section 312, a variant-attribute menu management section 313, and a path information management section 314 through execution of a display program stored in the storage medium (ROM, HDD, or the like) included in the storage section 33.

The menu management section 311 provides a menu managing function. The menu management section 311 manages a tree structure (hierarchized menu information) including a plurality of hierarchized menus. The menus are hierarchized according to their attributes (original attributes).

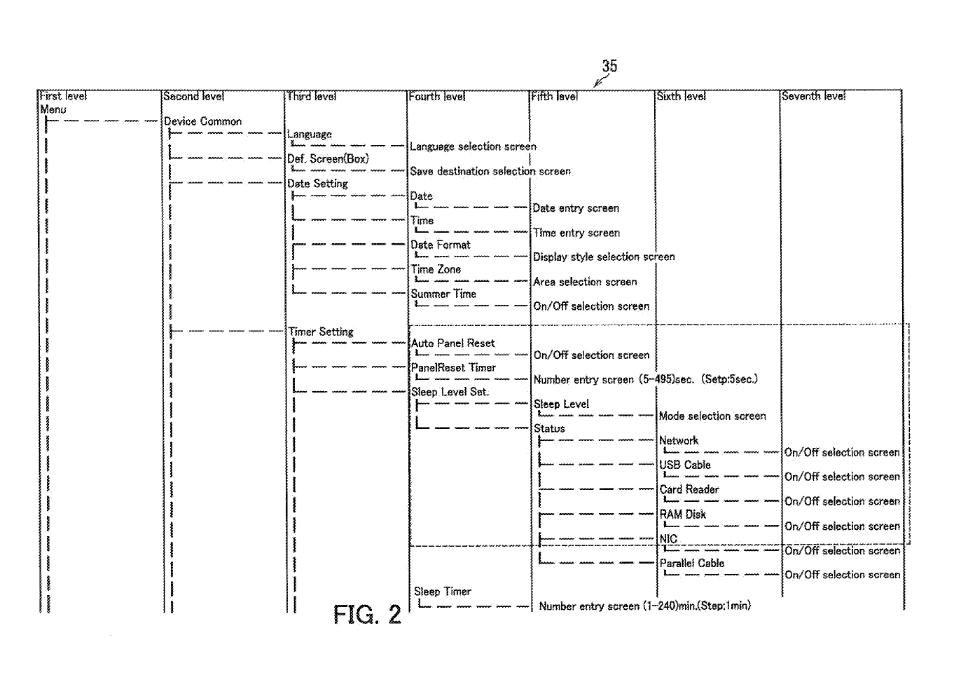

FIG. 2 is a diagram showing a tree structure (hierarchized menu information 35) to be managed by the menu management section 311. As shown in FIG. 2, the hierarchized menu information 35 is in the form of a tree structure. The tree structure includes a plurality of menus hierarchized according to their attributes (original attributes).

As shown in FIG. 2, the hierarchized menu information 35 is in first to seventh levels of hierarchy. Each level has at least one menu. The hierarchized menu information 35 is in the first level (highest level, “Menu”), the second level (“Device Common”), the third level (“Language”, “Def.Screen (BOX)”, “Date Setting”, and “Timer Setting”), and so on of hierarchy in this order according to their attributes (original attributes). That is, the menus are classified according to their attributes (original attributes) as shown in FIG. 2. The hierarchized menu information 35 is stored in the storage section 33.

The display processing section 312 in FIG. 1 provides a display processing function. When a menu (a higher-level menu) is selected based on the hierarchized menu information 35 (tree structure) shown in FIG. 2, the display processing section 312 displays on the display 22 a menu included in a level one level lower than the higher level and associated with the menu selected (hereinafter, may be referred to as display processing). The display processing by the display processing section 312 is executed through the display execution section 25 in the panel unit 20. The following description of the display processing by the display processing section 312 is on the assumption that the processing is executed through the display execution section 25. Hereinafter, a menu in a level one level lower than a higher level may be referred to as a next-lower-level menu.

Information for associating the menus in the non-first levels (second to seventh levels) with the menu in the highest level (first level) (information building the tree structure) is managed as first screen transition information. The first screen transition information is stored in the storage section 33.

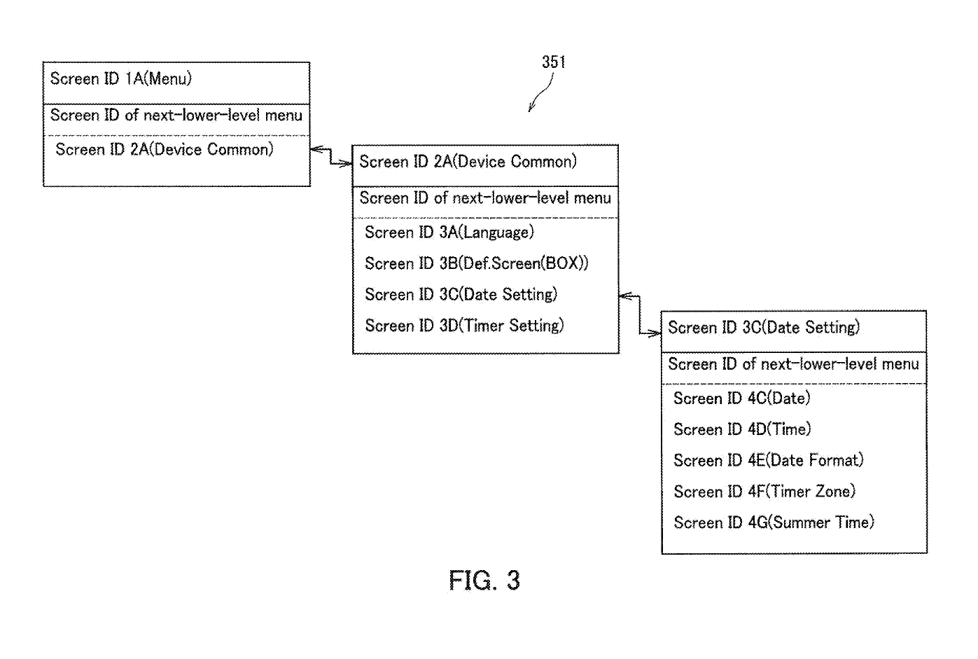

FIG. 3 is a conceptual diagram showing a part of the first screen transition information as the information building the tree structure shown in FIG. 2. Specifically, FIG. 3 shows some of the menus in the non-first levels (lower levels) associated with the menu in the highest level. As shown in FIG. 3, the first screen transition information 351 associates screen identification information (hereinafter, may be referred to as screen ID) of each menu in the tree structure of the hierarchized menu information 35 with substructure information. Specifically, the substructure information associated with a menu (a higher-level menu) includes a screen ID of a next-lower-level menu associated with the higher-level menu. If the substructure information of a higher-level menu includes a plurality of screen IDs, the screen IDs are associated with the screen ID of the higher-level menu in the form of a screen ID list.

Thus, when a higher-level menu in the hierarchized menu information 35 shown in FIG. 2 is displayed on the display 22, the display processing section 312 can display on the display 22 a selectable next-lower-level menu associated with the higher-level menu based on the first screen transition information 351 shown in FIG. 3.

Next, variant-attribute menus according to the present embodiment will be described with reference to FIGS. 1, 2, and 4. The variant-attribute menu management section 313 shown in FIG. 1 provides a variant-attribute menu managing function. The variant-attribute menu management section 133 manages the variant-attribute menus. The variant-attribute menus are associated with menus specified in the tree structure shown in FIG. 2 as quasi next-lower-level menus of the variant-attribute menus. The specified menus are classified according to attributes (variant attributes) of the variant-attribute menu. The variant attributes each refer to an attribute different from the attribute (original attribute) of each menu in the tree structure that is used as a reference when the tree structure is build. Thus, the specified menus are classified and associated with the variant-attribute menus according to their attributes (variant attributes) different from their original attributes. The variant-attribute menus are stored in the storage section 33 as next-lower-level menus of a guide menu 36, for example. The guide menu 36 is managed by the variant-attribute menu management section 313.

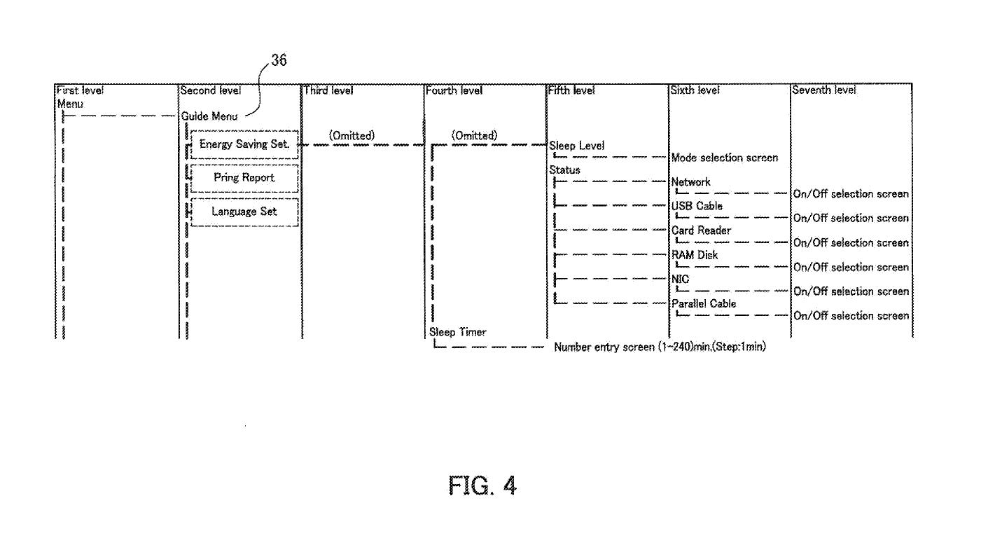

FIG. 4 is a diagram showing a plurality of quasi hierarchized menus. The guide menu 36 is inserted into any level in the tree structure of the hierarchized menu information 35 shown in FIG. 2. In the present embodiment, the guide menu 36 is inserted into the second level as shown in FIG. 4.

The variant-attribute menus as quasi third-level menus are associated with the guide menu 36 in the second level. In the present embodiment, three variant-attribute menus, that is, “Energy Saving Set. (energy saving setting)”, “Print Report (output pint report)”, and “Language Set (language setting)” are associated with the guide menu 36.

The three variant-attribute menus and the guide menu 36 are classified according to their variant attributes different from the attributes (original attributes) of the menus used as a reference when the menus are classified in the tree structure of the hierarchized menu information 35.

Specified menus as quasi next-lower-level menus are associated with any of the variant-attribute menus based on their attributes (variant attributes). For example, as quasi forth-level menus, “Sleep Timer” existing in the fourth level of the original tree structure, and “Sleep Level” and “Status” existing in the fifth level of the original tree structure are associated with “Energy Saving Set.” according to energy saving attributes. In this case, therefore, “Sleep Level” and “Status” are located in a level higher than their level in the original tree structure.

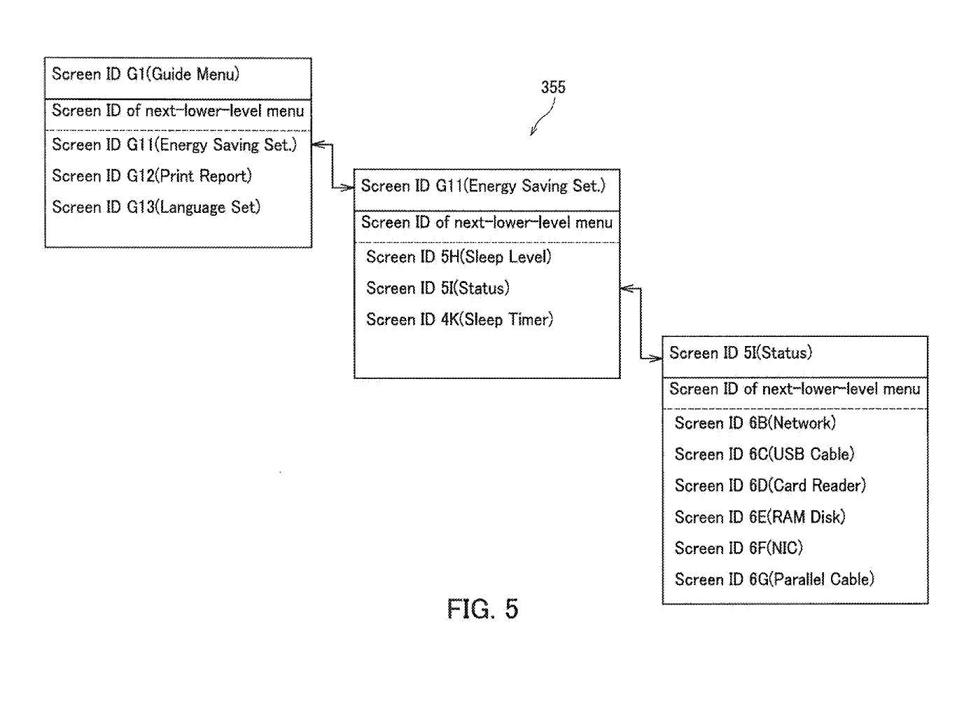

The variant-attribute menus and the specified menus are associated with one another based on second screen transition information 355 (see FIG. 5) as in the lower-level menus associated with a higher-level menu based on the first screen transition information 351 (see FIG. 3). The second screen transition information 355 is managed by the variant-attribute menu management section 313 and stored in the storage section 33.

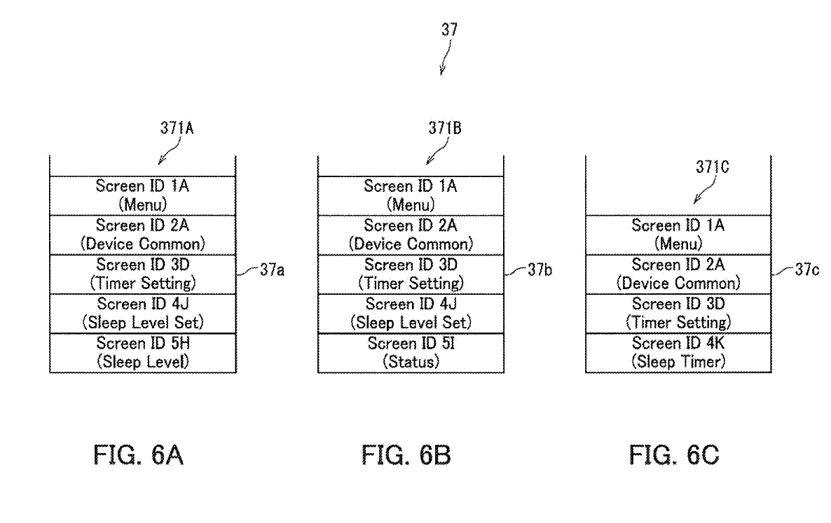

Next, management of path information will be described with reference to FIGS. 1 and 6A-6C. FIG. 6A is a diagram showing a data structure of the path information of “Sleep Level”. FIG. 6B is a diagram showing a data structure of the path information of “Status”. FIG. 6C is a diagram showing a data structure of the path information of “Sleep Timer”. The path information management section 314 shown in FIG. 1 provides a path information managing function. The path information management section 314 manages path information showing pathways to be selected to reach from the highest-level menu to a specified menu in the hierarchized menu information 35 (original tree structure). FIGS. 6A-6C show path information 371A, 371B, and 371C of the three specified menus “Sleep Level”, “Status”, and “Sleep Timer” respectively, associated as the next-lower-level menus with the variant-attribute menu “Energy Saving Set.”

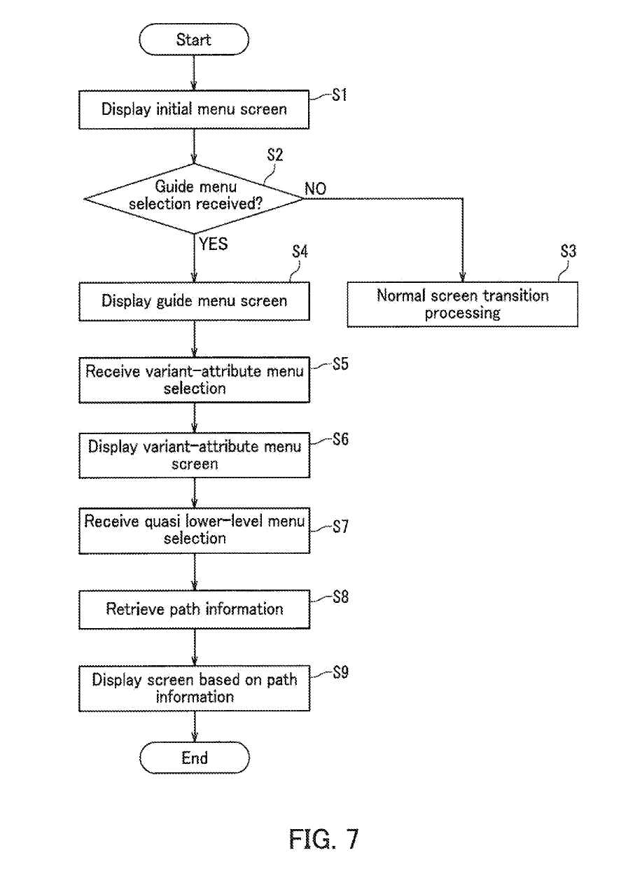

The path information of the specified menus is stored in a stack section 37 shown in FIG. 7. The stack section 37 has a data save area having a stack structure for each specified menu. That is, the path information of the specified menus is stored in the corresponding stack-structure data save areas. Specifically, the screen IDs of the menus existing in the respective pathways to be selected to reach from the highest-level (first-level) menu to the respective specified menus in the tree structure of the hierarchize menu information 35 are sequentially stored (stacked) in the corresponding data save areas as the path information of the respective specified menus. FIGS. 6A-6C show that the path information 371A, 371B, and 371C of the three specified menus associated with “Energy Saving Set.” is stored in the stack-structure data save areas 37A, 37b, and 37c, respectively. As shown in FIGS. 6A-6C, the path information 371A, 371B, and 371C each has a data structure in which the screen IDs of the menus existing in the pathways to be selected are stacked.

In the data save area 37a storing the path information 371A of “Sleep Level” in the fifth level, as shown in FIG. 6A, the screen ID (5H) of “Sleep Level”, the screen ID (4J) of “Sleep Level Set.” in the fourth level, the screen ID (3D) of “Timer Setting” in the third level, the screen ID (2A) of “Device Common” in the second level, and the screen ID (1A) of “Menu” in the first level are stacked from the bottom (first stack area) in this order.

In the data save area 37b storing the path information 371B of “Status” in the fifth level, as shown in FIG. 6B, the screen ID (5I) of “Status” is saved in the first stack area, and the subsequent screen IDs of the menus in the forth to first levels are stacked sequentially as in FIG. 6A.

In the data save area 37c storing the path information 371C of “Sleep Timer” in the fourth level, as shown in FIG. 6C, the screen ID (4K) of “Sleep Timer” is saved in the first stack area, and the screen ID (3D) of “Timer Setting” in the third level is saved in the next stack area. Subsequently, the screen IDs of the menus in the second and first levels are stacked sequentially as in FIGS. 6A and 6B.

The display processing section 312 displays a screen of the guide menu 36 (guide menu screen) on the display 22 based on the second screen transition information 355 (see FIG. 5). The screen of the guide menu 36 shows the variant-attribute menus associated with the guide menu 36. Once any of the variant-attribute menus is selected, the display processing section 312 displays on the display 22 a screen of the selected variant-attribute menu based on the second screen transition information 355. The screen of the variant-attribute menu shows quasi lower-level menus (specified menus) associated with the variant-attribute menu. The image forming apparatus 10 of the present embodiment can achieve transition to the screen of the quasi lower-level menus (specified menus) to be displayed on the display 22 by causing the display processing section 312 to refer to the path information as shown in FIGS. 6A-6C.

When the display 22 shows the screen of the variant-attribute menu “Energy Saving Set.” (energy saving setting screen), for example, the screen includes quasi lower-level menus (specified menus in the original tree structure) “Sleep Timer”, “Sleep Level,” and “Status” as selectable menus. Then, once “Sleep Timer”, “Sleep Level,” or “Status” is selected, the display processing section 312 refers to the path information 371A, 371B, or 371C shown in FIG. 6A, 6B, or 6C to retrieve the screen IDs from the data save area 37a, 37b, or 37c of the stack section 37 sequentially from the last stack area (the top area of the path information 371A, 371B, or 371C) through to the first stack area (the bottom area of the path information 371A, 371B, or 371C).

The display processing section 312 then displays on the display 22 the screen of “Sleep Timer”, “Sleep Level”, or “Status” based on the screen ID saved in the first stack area (the bottom area of the path information 371A, 371B, or 371C) and the first screen transition information 351 (tree structure). That is, the display 22 shows the next-lower-level menu representing “Sleep Timer”, “Sleep Level”, or “Status”.

### Display Processing

Next, the display processing by menu selection will be described with reference to FIGS. 1 to 7. FIG. 7 is a flowchart showing the display processing by menu selection according to the present embodiment.

The display processing of the present embodiment is started by operation of a menu key (operation key) included in the operating section 21 in the panel unit 20.

In Step S1, an initial menu screen is displayed. Specifically, the operation input section 24 in the panel unit 20 firstly receives operation of the menu key or the like and notifies the main control unit 30 of input data. In response to the notification, the display processing section 312 in the main control unit 30 displays on the display 22 the initial menu screen for the menu selection.

More specifically, upon receiving the notification from the operation input section 24, the display processing section 312 refers to the first screen transition information 351 and the second screen transition information 355 to acquire the screen ID of “Menu” in the highest level (first level) in the tree structure and the screen IDs of “Device Common” and “Guide Menu (guide menu)” in the second level that are associated with “Menu”.

Thereafter, the display processing section 312 acquires from the storage section 33 image data (character strings in the present embodiment) corresponding to the screen

IDs acquired, and then displays on the display 22 images (character strings) of “Menu”, “Device Common”, and “Guide Menu” based on the image data acquired. As a result, the initial menu screen is displayed.

Once the initial menu screen is displayed, the processing flows to Step S2.

In Step S2, the display processing section 312 determines whether or not selection of the guide menu 36 has been received. Specifically, once the operation input section 24 receives selection of any of the menus shown on the initial menu screen through operation of an operation key in the operating section 21, the display processing section 312 determines whether or not selection of the guide menu 36 has been received based on the data input from the operation input section 24.

More specifically, the display processing section 312 acquires the screen ID of the menu selected on the initial menu screen. The screen ID is acquired by referring to the first screen transition information 351 and the second screen transition information 355 as in the case of Step S1. The display processing section 312 determines, based on the screen ID acquired, whether or not the menu selected is the guide menu 36.

When the display processing section 312 determines that “Device Common” has been selected rather than the guide menu 36 (NO), then the processing flows to Step S3. When the display processing section 312 determines that the guide menu 36 has been selected (YES), then the processing flows to Step S4.

In Step S3, normal screen transition processing is performed. Specifically, the display processing section 312 refers to the first screen transition information 351 to acquire the screen ID of a next-lower-level menu of the menu selected. The display processing section 312 then displays on the display 22 a screen showing the content of the selected menu based on the image data corresponding to the screen ID acquired. Thereafter, every time any of the menus is selected, the display processing section 312 displays on the display 22 a next-lower-level menu showing the content of the menu selected.

In Step S4, on the other hand, the guide menu screen is displayed on the display 22. Specifically, the display processing section 312 displays the guide menu screen on the display 22 based on the second screen transition information 355.

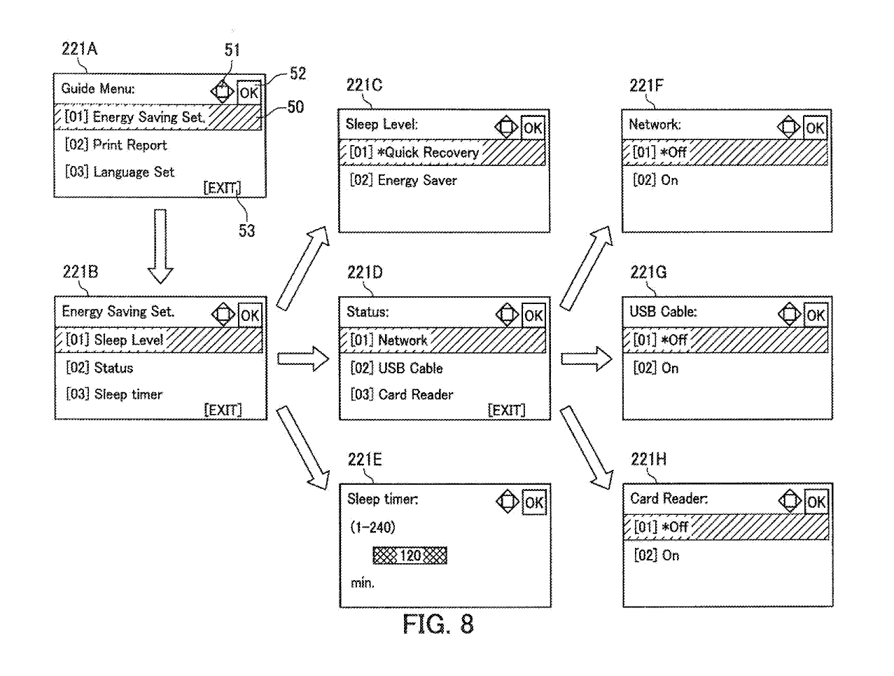

That is, the display processing section 312 refers to the second screen transition information 355 to acquire the screen IDs of the variant-attribute menus “Energy Saving Set.”, “Print Report”, and “Language Set” associated with the guide menu 36. The display processing section 312 then displays on the display 22 a screen showing the menus based on image data corresponding to the screen IDs acquired (see guide menu screen 221A shown in FIG. 8).

Once the guide menu screen is displayed, the processing flows to Step S5. In Step S5, selection of a variant-attribute menu is received. Specifically, upon receiving selection of any of the variant-attribute menus shown on the guide menu screen through operation of an operation key, the operation input section 24 notifies the display processing section 312 of the input data. Then, the processing flows to Step S6. In Step S6, a variant-attribute menu screen is displayed on the display 22.

Specifically, based on the notification from the operation input section 24, the display processing section 312 refers to the second screen transition information 355 as in Step S4 to acquire the screen IDs of quasi lower-level menus (specified menus in the original tree structure) associated with the variant-attribute menu selected. When “Energy Saving Set.” is selected, for example, the screen IDs of “Sleep Level”, “Status”, and “Sleep Timer” are acquired. The display processing section 312 then displays on the display 22 the variant-attribute menu screen based on image data corresponding to the screen IDs acquired (e.g., see energy saving setting screen 221B shown in FIG. 8).

Once the variant-attribute menu screen is displayed on the display 22, the processing flows to Step S7.

In Step S7, selection of a quasi lower-level menu is received. Specifically, upon receiving selection of any of the quasi lower-level menus (specified menus in the original tree structure) shown on the variant-attribute menu screen through operation of an operation key in the operating section 21, the operation input section 24 notifies the display processing section 312 of the input data. Then, the processing flows to Step S8.

In Step S8, path information is retrieved. Specifically, based on the notification of the input data from the operation input section 24, the display processing section 312 retrieves the path information of the quasi lower-level menu (specified menu) selected. When “Sleep Level”, “Status”, or “Sleep Timer” associated with “Energy Saving Set.” is selected, for example, the path information 371A, 371B, or 371C saved in the stack section 37 as shown in FIG. 6A, 6B, or 6C is retrieved.

That is, based on the screen IDs acquired in Step S6, the display processing section 312 retrieves the screen IDs from the data save area storing the path information of the quasi lower-level menu (specified menu) selected. More specifically, the display processing section 312 retrieves the screen IDs from the data save area sequentially from the screen ID in the last stack area through to the screen ID in the first stack area.

Once the path information is retrieved, the processing flows to Step S9.

In Step S9, a screen is displayed based on the path information. Specifically, based on the first screen transition information 351 and the screen ID retrieved from the first stack area, the display processing section 312 displays on the display 22 the content of the quasi lower-level menu selected (see screens 221C to 221E shown in FIG. 8).

Once the screen based on the path information is displayed on the display 22, the display processing of the present embodiment is ended. The quasi lower-level menu selected may further have a next-lower-level menu associated therewith. In this case, every time any of the menus is selected, the display processing section 312 displays on the display 22 a next-lower-level menu representing the content of the menu selected as in the normal screen transition processing.

### Example of Screen Transition According to Menu Selection

FIG. 8 is a diagram showing an example of screen transition from the guide menu 36 according to menu selection.

The screens 221A to 221H shown in FIG. 8 each have a cursor 50, a cursor key 51, an “OK” key 52, and an “EXIT” key 53. The cursor key 51 is used to input an instruction to move the cursor 50. The “OK” key 52 is used to input an instruction to select a designated menu. The “EXIT” key 53 is used to input an instruction to end the screen.

The guide menu screen 221A shown in FIG. 8 is a screen to be displayed in Step S4 shown in FIG. 7. The guide menu screen 221A shows the three variant-attribute menus as menus to be selected (selectable items), that is, “Energy Saving Set. (energy saving setting)”, “Print Report (output print report)”, and “Language Set (language setting)”.

A user can designate any of the variant-attribute menus on the guide menu screen 221A by moving the cursor 50 through operation of the cursor key 51. Further, the user can execute selection of the designated variant-attribute menu through operation of the “OK” key 52.

When “[01] Energy Saving Set.” is selected on the guide menu screen 221A, for example, the energy saving setting screen 221B shown in FIG. 8 is displayed as the variant-attribute menu screen in Step S6.

The energy saving setting screen 221B shows the three specified menus “Sleep Level”, “Status”, and “Sleep Timer” as the quasi lower-level menus associated with “Energy Saving Set”.

“Sleep Level”, “Status”, and “Sleep Timer” exist in different branches of the original tree structure, and thus they are not to be displayed on the same screen in nature. However, according to the present embodiment, they can be alternatively selected on the energy saving setting screen 221B. In addition, according to the present embodiment, it is possible to access each specified menu (e.g., “Sleep Level”, “Status”, or “Sleep Timer”) using the original tree structure by referring to the path information (see FIGS. 6A-6C). Subsequently, when “[01] Sleep Level” is selected on the energy saving setting screen 221B, for example, the sleep level setting screen 221C is displayed on the display 22. Alternatively, when “[02] Status” is selected on the energy saving setting screen 221B, the status setting screen 221D is displayed on the display 22. Alternatively, when “[03] Sleep Timer” is selected on the energy saving setting screen 221B, the sleep timer setting screen 221E is displayed on the display 22.

Thus, the energy saving setting screen 221B can transit to the sleep level setting screen 221C, the status setting screen 221D, or the sleep timer setting screen 221E.

The sleep level setting screen 221C shows menus (selectable menus) “Quick Recovery” and “Energy Saver”.

The status setting screen 221D shows menus (selectable menus) “Network (network setting)”, “USB Cable (USB cable setting), and “Card Reader (card reader setting). When “[01] Network” is selected on the status setting screen 221D, the network setting screen 221F is displayed. When “[02] USB Cable” is selected, the USB cable setting screen 221G is displayed. When “[03] Card Reader” is selected, the card reader setting screen 221H is displayed. A user can turn off or on the functions of the network, USB cable, and card reader by selecting “[01] Off” or “[02] On” on the network setting screen 221F, the USB cable setting screen 221G, or the card reader setting screen 221H, respectively.

In addition, the user can change the provisional setting value being displayed (“120” in this example) to a desired value and set the sleep timer to the changed value by pressing the “OK” key 52 on the sleep timer setting screen 221E.

### Advantages of Embodiment

The image forming apparatus 10 of the present embodiment includes the menu management section 311, the variant-attribute menu management section 313, the path information management section 314, and the display processing section 312. The menu management section 311 manages a tree structure including a plurality of menus hierarchized according to their attributes (original attributes). The variant-attribute menu management section 313 manages variant-attribute menus associated with specified menus out of the plurality of menus as quasi lower-level menus located in a quasi next lower level. The specified menus are classified according to their variant attributes different from the original attributes. The path information management section 314 manages path information showing pathways to be selected to reach the specified menus in the original tree structure. The display processing section 312 displays on a display the quasi lower-level menus according to selection of any of the variant-attribute menus. Once any of the quasi lower-level menus is selected, the display processing section 312 displays on the display a next-lower-level menu of the selected quasi lower-level menu based on the path information and the tree structure.

Thus, according to the present embodiment, the specified menus existing in different branches of the original tree structure can be collected as lower-level menus of a variant-attribute menu according to their variant attributes different from the attributes used as a reference when the original tree structure is built (original attributes). As a result, a user can alternatively select a desired menu on the same screen. That is, the image forming apparatus 10 can assist a user to perform efficient menu operation.

That is, according to the present embodiment, a user can cause the specified menus to be shown just by selecting a variant-attribute menu. The user can therefore straightforwardly access the specified menus without the need of going through every level of the tree structure sequentially to display the specified menus. Thus, the user can perform efficient menu operation. At the same time, the number of steps of menu operation can be reduced. The image forming apparatus 10 can assist efficient menu operation from this aspect as well.

In addition, according to the present embodiment, it is possible to display the content of a specified menu using the original tree structure by referring to the path information of the specified menu.

Furthermore, according to the present embodiment, the path information of each specified menu has a data structure in which screen IDs of the menus existing in pathways to be selected to reach the specified menu in the original tree structure are stacked. The display processing section 312 retrieves the stacked screen IDs of the menus sequentially from that of the highest-level menu and displays on the display the content of the specified menu (a next-lower-level menu of the specified menu) based on the screen ID of the specified menu retrieved lastly.

Thus, according to the present embodiment, it is possible to display the content of a specified menu easily and reliably.

The variant-attribute menus may be inserted into any level of the tree structure. Quasi lower-level menus associated as quasi next-lower-level menus with the variant-attribute menus are located in a level higher than the level of the corresponding specified menus in the tree structure.

Such a configuration can reliably reduce the number of steps of menu operation as compared with the case where a user goes through every level of the tree structure sequentially to access a specified menu.

### Variations

The variant-attribute menu management section 313 and the path information management section 314 may perform their management by independently acquiring necessary information from a server or an external storage connected to the image forming apparatus 10. Specifically, the variant-attribute menu management section 313 may acquire the guide menu 36, the variant-attribute menus, and the second screen transition information 355 from a server or an external storage. The path information management section 314 may acquire the path information from a server or an external storage.

In this case, the server and the external storage may store information corresponding to a plurality of types of apparatuses. Thus, the image forming apparatus 10 can acquire information corresponding to the type of itself.

Accordingly, the image forming apparatus 10 does not need to generate the guide menu 36, the variant-attribute menus, the second screen transition information 355, and the path information. As a result, a member of staff is allowed to easily generate and manage the guide menu 36 and so on.

If an authentication menu that requests user authentication exists in a level higher than a specified menu in path information, the display processing section 312 may display the authentication menu on the display 22 according to selection of a quasi lower-level menu (e.g., “Sleep Level”, “Status”, or “Sleep Timer”) associated with a variant-attribute menu (e.g., “Energy Saving Set. (energy saving setting)”).

A specified menu may become selectable after the user authentication. In this case, the screen ID of the authentication menu for the user authentication is saved in a stack area next to the stack area of the specified menu in the path information.

The path information management section 314 is configured to retrieve the stacked screen IDs sequentially. Thus, it is possible to retrieve the screen ID of the authentication menu before the screen ID of the specified menu to display the authentication menu.

Accordingly, even when the display processing is performed through the added guide menu 36, the image forming apparatus 10 can reliably request the user authentication to maintain security. Whether or not to display the authentication menu screen may be set by a user in advance.

Although a digital multifunction peripheral has been exemplified as the image forming apparatus 10 in the present embodiment, the image forming apparatus 10 is not limited to the digital multifunction peripheral and may be a printer, a facsimile machine, or a copy machine, for example.

What is claimed is:

1. An image forming apparatus comprising:
a menu management section configured to manage a tree structure including a plurality of menus hierarchized according to their attributes;
a variant-attribute menu management section configured to manage a variant-attribute menu associated with a specified menu out of the plurality of menus as a quasi lower-level menu located in a quasi next lower level, the specified menu being classified according to its variant attribute different from corresponding one of the attributes used for the tree structure;
a path information management section configured to manage path information showing pathways to be selected to reach the specified menu in the tree structure; and
a display processing section configured to display the quasi lower-level menu on a display according to selection of the variant-attribute menu and display, once the quasi lower-level menu is selected, a next-lower-level menu of the quasi lower-level menu on the display based on the path information and the tree structure.

2. An image forming apparatus according to claim 1, wherein
the path information has a data structure in which menus existing in the pathways to be selected are stacked, and
the display processing section retrieves the stacked menus sequentially from the highest-level menu in the data structure and displays on the display a next-lower-level menu of the quasi lower-level menu retrieved lastly.

3. An image forming apparatus according to claim 1, wherein
if an authentication menu that requests user authentication exists in a level higher than that of the specified menu in the tree structure, the display processing section displays the authentication menu on the display according to selection of the quasi lower-level menu.

4. An image forming apparatus according to claim 1, wherein
the variant-attribute menu management section and the path information management section perform their management by acquiring the variant-attribute menu and the path information, respectively, from a server or an external storage connected to the image forming apparatus.

5. An image forming apparatus according to claim 1, wherein
the variant-attribute menu is inserted into any level of the tree structure, and
the quasi lower-level menu is located in a level higher than the level of the specified menu in the tree structure.

6. A non-transitory computer-readable storage medium storing a display program to cause a computer to execute processing comprising:
managing a tree structure including a plurality of menus hierarchized according to their attributes;
managing a variant-attribute menu associated with a specified menu out of the plurality of menus as a quasi lower-level menu located in a quasi next lower level, the specified menu being classified according to its variant attribute different from corresponding one of the attributes used for the tree structure;
managing path information showing pathways to be selected to reach the specified menu in the tree structure;
displaying the quasi lower-level menu on a screen according to selection of the variant-attribute menu; and
displaying, once the quasi lower-level menu is selected, a next-lower-level menu of the quasi lower-level menu on the display based on the path information and the tree structure.
